(19) United States
(12) Patent Application Publication
(10) Pub. No.: US 2002/0143567 A1
(43) Pub. Date: Oct. 3, 2002

(54) Information-based digital currency and bartering

(76) Inventors: L. Michael Maritzen, Fremont, CA (US); Harold Aaron Ludtke, San Jose, CA (US); Kiyohiko Niwa, Haworth, NJ (US); Yoshihiro Tsukamura, Cresskill, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/013,595

(22) Filed: Dec. 7, 2001

Related U.S. Application Data
(60) Provisional application No. 60/252,343, filed on Nov. 20, 2000.
(60) Provisional application No. 60/294,858, filed on May 30, 2001.

(51) Int. Cl. G06F 17/60

(52) U.S. Cl. 705/1

(57) ABSTRACT

Information-based digital currency and bartering shares a pre-defined level of information about a consumer to a party offering an item to the consumer. A value for the item is based on the level of information shared with the party. In a barter situation with another consumer, a barter valuation for the level of information shared is calculated. The item may be a physical or non-physical product or a service.

### RELATED APPLICATIONS

This application claims the benefit of U.S. Provisional applications serial No. 60/252,343, filed Dec. 8, 2000, and Ser. No. 60/294,858, filed May 30, 2001.

### FIELD OF THE INVENTION

This invention relates generally to purchasing and bartering transactions, and more particularly to such transactions based on consumer information.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2000, Sony Electronics, Inc., All Rights Reserved.

### BACKGROUND OF THE INVENTION

Merchants, particularly those involved in on-line sales, want information about the consumers of their products and services and often also want to share the information with other merchants. Consumers, on the other hand, typically want to preserve their privacy and are often reluctant to disclose the information desired by the merchants. Common privacy procedures used by merchants are often neither secure nor trusted by the consumers.

### SUMMARY OF THE INVENTION

Information-based digital currency and bartering shares a pre-defined level of information about a consumer to a party offering an item to the consumer. A value for the item is based on the level of information shared with the party. In a barter situation with another consumer, a barter valuation for the level of information shared is calculated. The item may be a physical or non-physical product or a service.

The present invention describes systems, clients, servers, methods, and computer-readable media of varying scope. In addition to the aspects of the present invention described in this summary, further aspects will become apparent by reference to the drawings and by reading the detailed description that follows.

### BRIEF DESCRIPTION OF THE DRAWINGS

FIG. 1A is a diagram illustrating an overview of the operation of an embodiment of an information-based digital currency and barter system according to the invention.

FIG. 1B is a diagram illustrating an overview of the operation of an alternate embodiment of the information-based digital currency and barter system of FIG. 1A.

FIG. 2 is a flow diagram of a clearing house method to be performed by a computer according to the embodiments of FIGS. 1A-B.

FIG. 3 is a simplified block diagram of one embodiment of a secure transaction system.

FIG. 4 is a simplified block diagram of one embodiment of a privacy card for a personal transaction device.

FIG. 5 is a simplified block diagram of one embodiment of a digital wallet for a personal transaction device.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

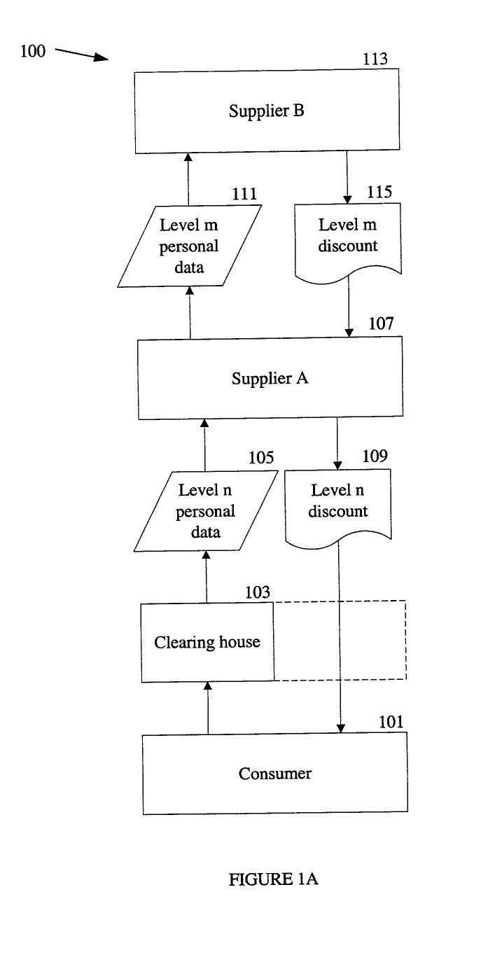

In an information-based digital currency and barter system 100 illustrated in FIG. 1A, a consumer 101 registers with a trusted-third party, illustrated as clearing house 103, and specifies a level of personal information 105 he or she permits the clearing house 103 to share with a supplier, such as supplier A 107, in exchange for a corresponding level of discount 109 for an item, such as a product or service, offered by the supplier. The clearing house 103 authenticates the consumer as being the party that originally registered with the clearing house 103. The authentication may be accomplished through a hardware token, such as a public-key interchange enabled security device. The authentication process may be performed locally or at a centralized location. The security device may be biometric, including fingerprint identifiers, retinal scans, DNA sequences, voice recognition, among others. Alternatively, the security device may be key-based, e.g., a PIN input device, or a combination of key-based and biometric devices. It will be appreciated that the representation of the consumer 101 in FIG. 1A encompasses a software agent acting on behalf of the actual consumer. Those of ordinary skill in the art will further appreciate that the products offered by the suppliers may be non-physical in nature, e.g., digital content such as music, video, audio, images, documents, and the like. In an alternate embodiment in which the supplier A 107 provides a service, the consumer 101 is given different levels of access to the service instead of discounts on the cost of the service.

The information may be requested by the supplier A 107 during activities such as purchase, registration, and identification (e.g., login/sign-on). The clearing house 103 responds to such requests with the level of information permitted by the consumer 101. The information sharing permissions specified by the consumer 101 may also allow the clearing house 103 to respond with a different level of personal information 105 if an additional discount is offered by certain suppliers.

The personal information may include traditional personal profile information, such as name, payment methods, accounts, ship-to/bill-to addresses, and phone number, and well as new digitally-available information, such as purchase history, vendor preferences, and “friends and family” relationship designations. The personal information may pre-defined into varying levels based on the confidentiality or other value of the information.

In one embodiment, three levels of information are pre-defined. Level 0 specifies that no personal information about the consumer 101 is provided by the clearing house 103, thus ensuring the consumer anonymity, and the corresponding discount level reflects a standard pricing model with no discounts. In an alternate environment, the supplier A 107 extends a discount to the consumer 101, even though the consumer is anonymous, because the clearing house 103 validation of the consumer 101 makes it more difficult for the consumer 101 to repudiate a transaction. At level 0, the supplier A 107 may be unable send the discount information 109 directly to the consumer 101 since the consumer is anonymous, so the clearing house 103 receives and forwards the discount 109 to the consumer 101 (shown in phantom in FIG. 1A).

Level 1 specifies that only “public” information about the consumer 101 is provided to the supplier A 107, with a corresponding discount level equivalent to a membership-style pricing model. Public information may include name, transaction amount of current purchase, merchant, and current session navigation information. Level 2 specifies that “controlled private” information is provided and the corresponding discount level reflects a premium discount model. Controlled private information may include cross-merchant/cross-session purchases and navigation, specific products or services purchased, location of purchase, ship-to addresses, survey data, and referral contact information.

In addition to facilitating the exchange information for discounts by the consumer 101 and the supplier A 107, the system 100 may also provide the supplier A 107 a discount 115 on transaction fees and costs of items acquired from supplier B 113, depending on a secondary level of information 111 about the consumer 101 the supplier A 107 shares with the supplier B 113. The consumer 101 authorizes the secondary level of information 111 for sharing by certain suppliers through the clearing house 103. Because the discounts 115 can result in even greater discounts 109 to the consumer 101, the consumer benefits by allowing the sharing of some of his/her information with other merchants. Additionally, the supplier A 107 may share some of its own information, such as sales, manufacturing and fulfillment, and distribution channel data, to obtain a higher level of discount 115.

For example, assume the consumer A 101 has registered with the clearing house 103 using a biometric device and has selected level 1 information sharing as a global default for purchases from suppliers. In addition, the consumer 101 has specified that certain suppliers may be given level 2 information upon request in exchange for an additional discount of more than 25% at the time of purchase. When the consumer A 101 initiates a purchase transaction through the clearing house 103, the clearing house authenticates the consumer based on the security information stored at the time of registration. The clearing house 103 interacts with the supplier(s) specified by the consumer 101 in the transaction to send the appropriate level(s) of information, and an indication of what portions, if any, of the information may be secondarily shared with other suppliers.

When a consumer is bartering with another consumer for an exchange of products or services, an alternate embodiment of the information-based digital currency and barter system 120 illustrated in FIG. 1B may be used. Both consumer A 121 and consumer B 125 register with a clearing house 129. During negotiations, each consumer specifies the level of information 123, 127 the consumer is willing to share with the other consumer. The clearing house 129 places a barter valuation 131, 133 on amount, type, nature and quality of the information to be shared. The consumer A 121 and B 125 take the barter valuations into account when determining values of the items to be bartered. One or both of the consumers may elect to share a different level of information to change the corresponding barter valuation. In an alternate embodiment, one of the consumers can suggest a different barter valuation through the clearing house 129 in exchange for certain additional information about the other consumer. In one embodiment, the levels of information are comparable to those described for the system 100 in FIG. 1.

In another alternate embodiment not illustrated, only one of the consumers is registered with the clearing house 129. It will be appreciated that any number of consumers may be involved in the barter that not all the involved consumers may be registered with the clearing house 129. Alternatively, an additional consumer or supplier may be indirectly involved in the barter similar to the supplier B 113 in FIG. 1A.

For example, assume that the consumer A 121 has registered with the clearing house 129 using a biometric device and has selected level 1 information sharing as a global default for bartering with other consumers. In addition, the consumer A 121 has specified that consumer C can be given level 2 information to increase the barter valuation of consumer A, if necessary. Although consumer C is not registered with the clearing house 129, the consumer A 121 has an established relationship with consumer C. Consumer A 121 proposes a barter of yard maintenance services by consumer A in exchange for tax preparation services by consumer C. The clearing house 129 authenticates the consumer A 121 and calculates a barter valuation of the level 1 information consumer A 121 is willing to share with consumer C. If consumer C counters with a request for certain level 2 information, the clearing house 129 will calculate the barter valuation of the additional information. The final barter agreed upon by the consumer will be based on the barter valuation supplied by the clearing house 129, e.g., three houses of yard maintenance in exchange for one tax preparation session. Additionally, supplier D that offers copying services to consumer C may be an indirect participant in the barter if supplier D is willing to reduce copy costs in exchange for consumer C sharing information about consumer A.

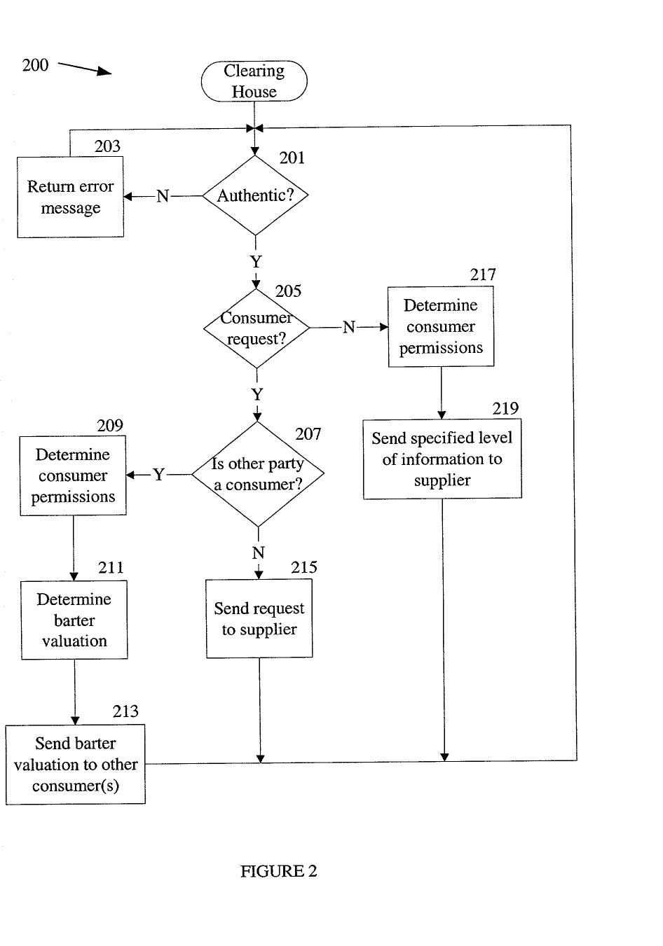

In one embodiment, the clearing house is a computer server or group of servers operated by the trusted third-party. The consumer accesses the clearing house server through a user device that connects to the server(s) through a wired or wireless connection to a network, such as the Internet. The user device operates in conjunction with the security device to authenticate the consumer to the clearing house. Exemplary embodiments of a clearing house and user devices are described further below in conjunction with FIGS. 3-5.

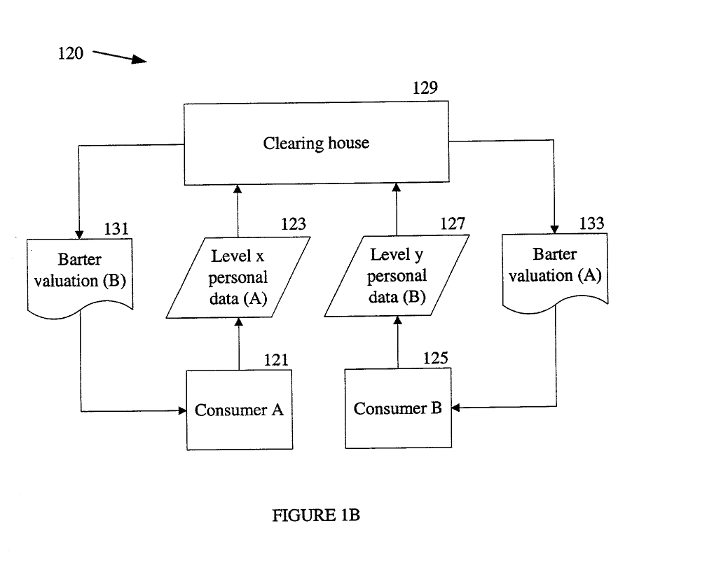

Next, the particular methods of the invention are described in terms of computer software with reference to a flow diagram in FIG. 2 that performs the functions described above for the clearing house. The methods constitute computer programs made up of computer-executable instructions illustrated as blocks (acts) 201 until 219 in FIG. 2. Describing the methods by reference to a flow diagram enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It further will be appreciated that more or fewer processes may be incorporated into the methods illustrated in FIG. 2 without departing from the scope of the invention and that no particular order is implied by the arrangement of blocks shown and described herein.

The clearing house method 200 receives requests from consumers and from suppliers. The method 200 attempts to authenticate the requester (block 201), and if the requestor cannot be authenticated, an error message is returned to the requestor (block 203). If the request is from an authenticated consumer (block 205), the method 200 determines if the consumer is transacting with another consumer or a supplier (block 207). If the other party is a consumer, the method 200 determines the consumer's information sharing permissions in dealing with another consumer (block 209). The method 200 determines a barter valuation for the level of shared information permitted (block 211) and sends the barter validation to the other consumer(s) involved in the transaction (block 213).

If the other party is not a consumer (block 207), the method 200 sends the request to the identified supplier(s). Assuming the supplier responds to the request and is authenticated (blocks 201 and 205), the method 200 determines the consumer information sharing permissions in dealing with the supplier (block 217). The specified level of information is sent to the supplier (block 219). Offers of additional discounts from a supplier in exchange for a different level of consumer information are processed in the same fashion.

In one embodiment, a consumer-centric context-aware switching model is used to automatically transfer the consumer information among the other parties transacting with the consumer. The consumer information is consolidated into one or more data objects that are shared with the parties in accordance with the consumer permissions as the consumer proceeds through the transaction flow. Details of the model are disclosed in U.S. patent application serial number 09/______ (attorney docket number Sony 00500), titled “Consumer-Centric Context-Aware Switching Model,” filed on December ______ , 2001 and assigned to the same assignee as the present application.

FIG. 3 is a block diagram of one embodiment of a secure transaction system, which may be used in electronic commerce, such as the information-based digital currency and barter systems described in conjunction with FIGS. 1A and 1B. In this embodiment, a transaction privacy clearing house (TPCH) 315 interfaces a user (consumer) 340 and a vendor 325. For consumer-to-consumer barter, vendor 325 is another consumer. In this particular embodiment, a personal transaction device (PTD) 370, e.g., a privacy card 305, or a privacy card 305 coupled to a digital wallet 350, is used to maintain the privacy of the user while enabling the user to perform transactions. In an alternate embodiment, the PTD 370 may be any suitable device that allows unrestricted access to TPCH 315. The personal transaction device information is provided to the TPCH 315 that then indicates to the vendor 325 and the user 340 approval of the transaction to be performed.

In order to maintain confidentiality of the identity of the user 340, the transaction device information does not provide user identification information. Thus, the vendor 325 or other entities do not have user information but rather transaction device information. The TPCH 315 maintains a secure database of transaction device information and user information. In one embodiment, the TPCH 315 interfaces to at least one financial processing system 320 to perform associated financial transactions, such as confirming sufficient funds to perform the transaction, and transfers to the vendor 325 the fees required to complete the transaction. In addition, the TPCH 315 may also provide information through a distribution system 330 that, in one embodiment, can provide a purchased product to the user 340, again without the vendor 325 knowing the identification of the user 340. In an alternate embodiment, the financial processing system 320 need not be a separate entity but may be incorporated with other functionality. For example, in one embodiment, the financial processing system 320 may be combined with the TPCH 315 functionality.

In one embodiment, the financial processing system (FP) 320 performs tasks of transferring funds between the user's account and the vendor's account for each transaction. In one embodiment, the presence of the TPCH 315 means that no details of the transactions, other than the amount of the transactions and other basic information, are known to the FP 320. The TPCH 315 issues transaction authorizations to the FP 320 function on an anonymous basis on behalf of the user over a highly secure channel. The FP 320 does not need to have many electronic channels receiving requests for fund transfer, as in a traditional financial processing system. In one embodiment, a highly secure channel is set up between the TPCH 315 and the FP 320; thus, the FP 320 is less vulnerable to spoofing.

In one embodiment, the FP 320 is contacted by the TPCH 315 requesting a generic credit approval of a particular account. Thus the FP 320 receives a minimal amount of information. In one embodiment, the transaction information, including the identification of products being purchased with the credit need not be passed to the FP 320. The TPCH 315 can request the credit using a dummy charge ID that can be listed in the monthly credit statement sent to the user, so that the user can reconcile his credit statement. Further, the personal transaction device 370 can include functionality to cause the credit statement to convert the dummy charge ID back to the transactional information so that the credit statement appears to be a conventional statement that lists the products that were purchased and the associated amount charged.

A display input device 360 (shown in phantom) may be included to enable the user, or in some embodiments the vendor 325, to display status and provide input regarding the PTD 370 and the status of the transaction to be performed.

In yet another embodiment, an entry point 310 interfaces with the personal transaction device 370 and also communicates with the TPCH 315. The entry point 310 may be an existing (referred to herein as a legacy POS terminal) or a newly configured point of sale (POS) terminal located in a retail environment. The user 340 uses the PTD 370 to interface to the POS terminal in a manner similar to how credit cards and debit cards interface with POS terminals. The entry point 310 may also be a public kiosk, a personal computer, or the like.

The system described herein also provides a distribution functionality 330 whereby products purchased via the system are distributed. In one embodiment, the distribution function 330 is integrated with the TPCH 315 functionality. In an alternate embodiment, the distribution function 330 may be handled by a third party. Utilizing either approach, the system ensures user privacy and data security. The distribution function 330 interacts with the user through PTD 330 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 370 to change the shipping address of the product at any time during the distribution cycle.

A user connects to and performs transactions with a secure transaction system (such as shown in FIG. 3) through a personal transaction device (PTD) that has a unique identifier (ID). In one embodiment, a privacy card is used. In an alternate embodiment a digital wallet is used. In yet another alternate embodiment, a privacy card in conjunction with a digital wallet is used.

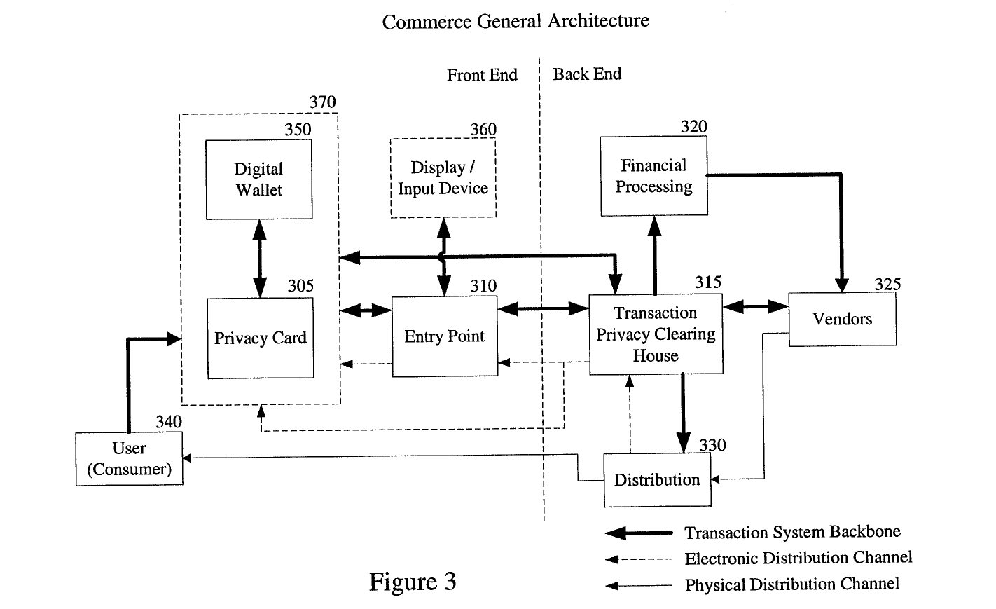

One embodiment of a privacy card 405 is illustrated in FIG. 4. In one embodiment, the card 405 is configured to be the size of a credit card. The privacy card includes a processor 410, memory 415 and input/output logic 420. The processor 410 is configured to execute instructions to perform the functionality herein. The instructions may be stored in the memory 415. The memory is also configured to store data, such as transaction data and the like. In one embodiment, the memory 415 stores the transaction ID used to perform transactions in accordance with the teachings of the present invention. Alternately, the processor may be replaced with specially configured logic to perform the functions described here.

The input/output logic 420 is configured to enable the privacy card 405 to send and receive information. In one embodiment, the input/output logic 420 is configured to communicate through a wired or contact connection. In another embodiment, the logic 420 is configured to communicate through a wireless or contactless connection. A variety of communication technologies may be used.

In one embodiment, a display 425 is used to generate bar codes scanable by coupled devices and used to perform processes as described herein. The privacy card 405 may also include a magnetic stripe generator 440 to simulate a magnetic stripe readable by devices such as legacy POS terminals.

In one embodiment, biometric information, such as fingerprint recognition, is used as a security mechanism that limits access to the card 405 to authorized users. A fingerprint touch pad and associated logic 430 is therefore included in one embodiment to perform these functions. Alternately, security may be achieved using a smart card chip interface 450, which uses known smart card technology to perform the function.

Memory 415 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 415 can also have user identity/account information block. The user identity/account information block stores data about the user and accounts that are accessed by the card. The type of data stored includes the meta account information used to identify the account to be used.

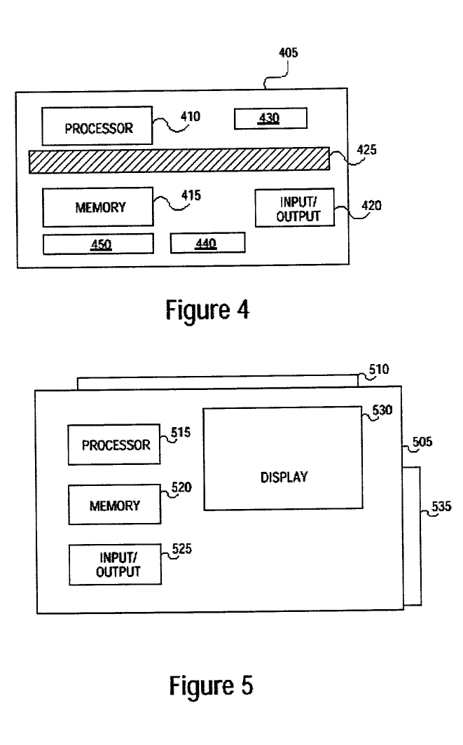

One embodiment of a digital wallet 505 is illustrated in FIG. 5. The digital wallet 505 includes a coupling input 510 for the privacy card 405, processor 515, memory 520, input/output logic 525, display 530 and peripheral port 535. The processor 515 is configured to execute instructions, such as those stored in memory 520, to perform the functionality described herein. Memory 520 may also store data including financial information, eCoupons, shopping lists and the like. The digital wallet may be configured to have additional storage. In one embodiment, the additional storage is in a form of a card that couples to the device through peripheral port 510.

In one embodiment, the privacy card 405 couples to the digital wallet 505 through port 510; however, the privacy card 405 may also couple to the digital wallet 505 through another form of connection including a wireless connection.

Input/output logic 525 provides the mechanism for the digital wallet 505 to communicate information. In one embodiment, the input/output logic 525 provides data to a point-of-sale terminal or to the privacy card 405 in a pre-specified format. The data may be output through a wired or wireless connection.

The digital wallet 505 may also include a display 530 for display of status information to the user. The display 530 may also provide requests for input and may be a touch sensitive display, enabling the user to provide the input through the display.

The physical manifestation of many of the technologies in the digital wallet 505 will likely be different from those in the privacy card 405, mainly because of the availability of physical real estate in which to package technology. Examples of different physical representations would include the display, fingerprint recognition unit, etc.

The components of a secure transaction system illustrated in FIGS. 3, 4, and 5 are further described in PCT published U.S. patent application Ser. No. 00/35619, which is assigned to the same assignee as the present application and which is hereby incorporated by reference.

Information-based digital currency and bartering that exchanges various levels of consumer information for corresponding levels of discounts, levels of access, or barter valuations for items has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

What is claimed is:

1. A computerized method comprising:
receiving a request from a party for information about a consumer;
determining a level of information sharable with the party, wherein a value for an item offered by the party to the consumer is based on the level of information shared; and
sending the level of information in response to the request.

2. The computerized method of claim 1 further comprising:
receiving a default of a particular level of information sharable with parties from the consumer.

3. The computerized method of claim 1 further comprising:
receiving an association of a particular level of information with a particular party from the consumer.

4. The computerized method of claim 1 further comprising:
determining a subsequent level of information sharable with the party, wherein sharing the subsequent level of information lowers the value of the item.

5. The computerized method of claim 1 further comprising:
determining a secondary level of information that is sharable by the party with another party.

6. The computerized method of claim 1 further comprising:
calculating a barter valuation for the level of information sharable with the party when the party is a consumer.

7. The computerized method of claim 1, wherein the item is selected from the group consisting of physical products, non-physical products, and services.

8. The computerized method of claim 7, wherein the value of a service represents a level of access to the service.

9. The computerized method of claim 1 further comprising:
authenticating the consumer.

10. The computerized method of claim 9, wherein the level of information does not identify the consumer to the party.

11. The computerized method of claim 1 further comprising:
authenticating the party.

12. A computer-readable medium having computer-executable instructions to cause a computer to perform a method comprising:
receiving a request from a party for information about a consumer;
determining a level of information sharable with the party, wherein a value for an item offered by the party to the consumer is based on the level of information shared; and
sending the level of information in response to the request.

13. The computer-readable medium of claim 12, wherein the method further comprises:
receiving a default of a particular level of information sharable with parties from the consumer.

14. The computer-readable medium of claim 12, wherein the method further comprises:
receiving an association of a particular level of information with a particular party from the consumer.

15. The computer-readable medium of claim 12, wherein the method further comprises:
determining a subsequent level of information sharable with the party, wherein sharing the subsequent level of information lowers the value of the item.

16. The computer-readable medium of claim 12, wherein the method further comprises:
determining a secondary level of information that is sharable by the party with another party.

17. The computer-readable medium of claim 12, wherein the method further comprises:
calculating a barter valuation for the level of information sharable with the party when the party is a consumer.

18. The computer-readable medium of claim 12, wherein the item is selected from the group consisting of physical products, non-physical products, and services.

19. The computer-readable medium of claim 18, wherein the value of a service represents a level of access to the service.

20. The computer-readable medium of claim 12, wherein the method further comprises:
authenticating the consumer.

21. The computer-readable medium of claim 20, wherein the level of information does not identify the consumer to the party.

22. The computer-readable medium of claim 12, wherein the method further comprises:
authenticating the party.

23. A computer system comprising:
a processor coupled to a memory through a bus;
a network interface coupled to the processor through the bus; and
a clearing house process executed by the processor from the memory to cause the processor to receive a request from a party for information about a consumer through the network interface, to determine a level of information sharable with the party, wherein a value for an item offered by the party to the consumer is based on the level of information shared, and to send the level of information in response to the request through the network interface.

24. The computer system of claim 23, wherein the clearing house process further causes the processor to receive a default of a particular level of information sharable with parties from the consumer through the network interface.

25. The computer system of claim 23, wherein the clearing house process further causes the processor to receive an association of a particular level of information with a particular party from the consumer through the network interface.

26. The computer system of claim 23, wherein the clearing house process further causes the processor to determine a subsequent level of information sharable with the party, wherein sharing the subsequent level of information lowers the value of the item.

27. The computer system of claim 23, wherein the clearing house process further causes the processor to determine a secondary level of information that is sharable by the party with another party.

28. The computer system of claim 23, wherein the clearing house process further causes the processor to calculate a barter valuation for the level of information sharable with the party when the party is a consumer.

29. The computer system of claim 23, wherein the item is selected from the group consisting of physical products, non-physical products, and services.

30. Thee computer system of claim 29, wherein the value of a service represents a level of access to the service.

31. The computer system of claim 23, wherein the clearing house process further causes the processor to authenticate the consumer.

32. The computer system of claim 3 1, wherein the level of information does not identify the consumer to the party.

33. The computer system of claim 23, wherein the clearing house process further causes the processor to authenticate the party.
